(19) United States
(12) Patent Application Publication
(10) Pub. No.: US 2022/0341243 A1
(43) Pub. Date: Oct. 27, 2022

(54) FLUID-DRIVEN HATCH

(71) Applicant: DCL, Inc., Charlevoix, MI (US)

(72) Inventor: Reinhard Matye, Charlevoix, MI (US)

(21) Appl. No.: 17/724,771

(22) Filed: Apr. 20, 2022

Related U.S. Application Data
(60) Provisional application No. 63/177,592, filed on Apr. 21, 2021.

(51) Int. Cl. E05F 15/53; E05B 51/02; E05B 81/10; E05B 81/18; E05B 83/02; B60P 3/22

(52) U.S. Cl. CPC E05F 15/53; E05B 51/02; E05B 81/10; E05B 81/18; E05B 83/02; B60P 3/2205; E05Y 2201/454; E05Y 2201/456; E05Y 2201/458; E05Y 2201/716; E05Y 2201/722; E05Y 2800/10; E05Y 2900/516

(57) ABSTRACT

A fluid-driven hatch for a bulk material container includes a cover is opened by a fluid-driven cover actuator and secured by a fluid-driven lock actuator. A fluid conduit connects both the fluid-driven cover actuator and the fluid-driven lock actuator to a pressurized fluid source. Pressurized fluid is selectively supplied to the fluid conduit such that the fluid-driven lock actuator is actuated at a first pressure to unlock the cover, and the fluid-driven cover actuator is actuated moments later at a second, higher pressure to open the cover.

### CROSS REFERENCE TO RELATED APPLICATION

The present application claims the benefit of U.S. provisional application Ser. No. 63/177,592, filed on Apr. 21, 2021, which is hereby incorporated herein by reference in its entirety.

### FIELD OF THE INVENTION

The present invention relates generally to an opening and closing device, and more particularly, to a hatch opening and closing device for a container, especially a bulk material container on a vehicle such as a rail car or trailer truck.

### BACKGROUND OF THE INVENTION

Vehicles for hauling bulk materials, such as ash, cement, lime, plastic resin, fertilizers, chemicals, grains, liquid fuels, and the like, may include one or more storage containers. Similar storage containers may also be used in fixed locations. Each storage container will generally include at least one fill opening at the top, fitted with a removable or openable hatch assembly for selectively covering the opening in the container. Mechanisms can be added to the hatch assembly to facilitate the process of opening and closing the hatch assembly at the opening of the container.

### SUMMARY OF THE INVENTION

The fluid-driven hatch of the present invention provides a method and system that is adapted for automatically covering and uncovering an opening in a bulk material container. A cover is movable by a fluid-driven cover actuator between an open configuration in which the opening is substantially uncovered, and a closed configuration in which the opening is substantially covered. A single fluid line may be used to actuate a lock release and to actuate the fluid-driven cover actuator in sequence, using different fluid pressures in the fluid line. The fluid-driven hatch is remotely operable by an operator to unlock, open, close, and lock the cover via one or more remote hatch controls such as one or more buttons or toggle switches that can be remotely mounted at a relatively safe and convenient location, such as along the ground or support surface, or in the cab of a vehicle.

According to one form of the invention, a fluid-driven hatch is adapted for use at a hatch opening formed in a bulk material container, and includes a fluid-driven cover actuator coupled to a hatch cover, and a locking device with a latch and a fluid-driven lock actuator. The cover actuator moves the cover between an open configuration in which the hatch opening is substantially uncovered, and a closed configuration in which the hatch opening is substantially covered. A fluid conduit fluidly connects a fluid drive source to the cover actuator and the lock actuator. When the cover is in the closed configuration, the fluid force produced from the fluid drive source can be controlled to increase the fluid pressure in the fluid conduit. When the fluid conduit reaches a first internal pressure, the lock actuator is actuated to move the latch from a locked position to an unlocked position to unlock the cover. When the fluid conduit reaches a second internal pressure, the cover actuator is actuated to move the cover to the open configuration. The cover may be moved to the closed configuration and secured to the container at the hatch opening by redirecting or changing the fluid pressure within the fluid conduit.

In one aspect, while the cover is in the closed configuration, the latch moves from the locked position to the unlocked position in response to the first internal pressure before the cover begins to move from the closed configuration to the open configuration in response to the second internal pressure.

In another aspect, the fluid conduit connects the cover actuator and the lock actuator in fluid parallel with one another.

In yet another aspect, the first internal pressure is lower than the second internal pressure.

In still another aspect, the fluid-driven hatch includes a remote hatch control operable to move the cover between the open and closed configurations. Optionally, the remote hatch control is operable to move the latch between the locked and unlocked positions.

In a further aspect, the locking device includes a latch pivot about which the latch rotates between the locked and unlocked positions in response to the lock actuator. In the locked position, the latch is engaged with a latch receiver to secure the cover in the closed configuration. In the unlocked position, the latch is disengaged from the latch receiver. Optionally, a distal portion of the latch includes a ramp surface and a catch surface. As the cover moves towards the closed configuration, the ramp surface slides along the latch receiver causing the latch to pivot towards the unlocked position. Once the ramp surface slides past the latch receiver, the latch pivots back into the locked position where the catch surface engages with the latch receiver.

In yet a further aspect, the fluid-driven hatch includes a bidirectional valve that is fluidly connected to the fluid conduit, and that can be toggled between an opening state and a closing state. In the opening state, the fluid pressure at the lock actuator is increased to the first internal pressure. In the closing state, the fluid pressure at the lock actuator is decreased to less than the first internal pressure.

In still a further aspect, the cover actuator includes a first end, a second end, and a cover actuation rod. When the bidirectional valve is in the opening state, the fluid pressure at the second end of the cover actuator increases to the second internal pressure to urge the cover actuation rod away from the second end of the cover actuator. Optionally, a rack and pinion assembly is coupled to the cover and the cover actuation rod to rotate the cover towards the open configuration as the rack and pinion assembly is actuated by the movement of the cover actuation rod away from the second end of the cover actuator.

In another aspect, the lock actuator is coupled to a resilient member that exerts a biasing force on the lock actuator in a direction opposite to the fluid force exerted on the lock actuator by the fluid drive source. Thus, the biasing member urges the lock actuator to move the latch toward the locked position, and is selectively overcome by the fluid force exerted on the lock actuator to move the latch toward the unlocked position.

Thus, the fluid-driven hatch of the present invention allows for the selective covering of an opening in a bulk material container. This is accomplished through a fluid drive source that is fluidly connected to a fluid-driven cover actuator and a fluid-driven lock actuator via a fluid conduit. The fluid force produced from the fluid drive source is controllable to provide fluid pressure to both the cover actuator, to selectively cover and uncover the opening with a hatch cover, and the lock actuator to unsecure the cover in the covered or closed configuration.

These and other objects, advantages, purposes and features of the present invention will become apparent upon review of the following specification in conjunction with the drawings.

### BRIEF DESCRIPTION OF THE DRAWINGS

FIG. 1 is a side elevation view of a trailer truck with a pair of fluid-driven hatches in accordance with the present invention;

FIG. 2 is a perspective view of a pneumatically-driven hatch in accordance with the present invention, shown with a hatch cover fully closed;

FIG. 3 is a perspective view of the pneumatically-driven hatch of FIG. 2, shown with the hatch cover partially open;

FIG. 4 is another perspective view of the pneumatically-driven hatch of FIG. 2;

FIG. 5 is a top plan view of the pneumatically-driven hatch of FIG. 2;

FIG. 6 is an enlarged view of the area designated VI in FIG. 5, depicting a locking device of the pneumatically-driven hatch;

FIG. 7 is a side elevation view of the pneumatically-driven hatch of FIG. 2, with a side plate removed to show additional detail of the locking device and a latch receiver;

FIG. 8 is an enlarged view of the area designated VIII in FIG. 7, depicting the locking device of the pneumatically-driven hatch and the latch receiver;

FIG. 9 is an enlarged perspective view of the locking device of the pneumatically-driven hatch of FIG. 2; and

FIG. 10 is a fluid diagram representing the fluid system of the pneumatically-driven hatch of FIG. 2.

### DETAILED DESCRIPTION OF THE PREFERRED EMBODIMENTS

A fluid-driven hatch provides a system and method to selectively cover an opening in a bulk material container. The bulk material container may be associated with vehicles such as rail cars and trailer trucks or, alternatively, could be a stationary container. The fluid-driven hatch utilizes a fluid drive source, such as a pneumatic drive commonly found on rail cars and trailer trucks, to generate a fluid force. The fluid force is transferred through a single fluid conduit that fluidly connects a fluid-driven cover actuator and a fluid-driven lock actuator. Once the fluid pressure in the fluid conduit increases to a first (lower) fluid pressure, the lock actuator is actuated to unlock a closed hatch cover. After the cover is unlocked, the fluid pressure continues to increase until a second (higher) fluid pressure is reached to actuate the cover actuator and open the hatch cover. Using the same components, the hatch cover may be closed and secured to the bulk material container by redirecting or otherwise changing the fluid pressure. Controls to open, close, lock, and unlock the cover may be located remotely in a convenient location for an operator to access.

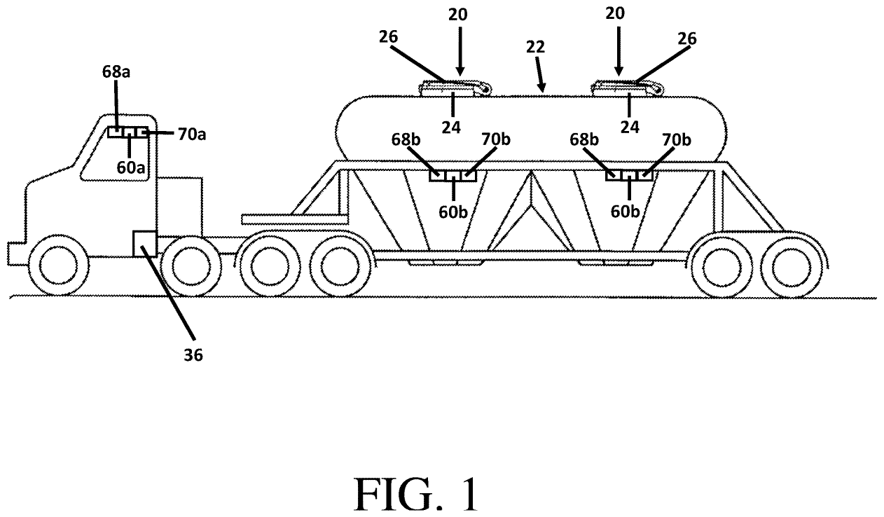

Referring now to the drawings and the illustrative embodiments depicted therein, a pneumatically-driven hatch 20 for a bulk material container 22, which may be a fixed container or a portable container that is towable by a train or road vehicle, is shown in FIGS. 1-3. Hatch 22 includes a base 24 that is coupled to (or is part of) container 22 at an opening 32 formed therein, and a cover 26 that is pivotably coupled to base 24 via a frame 28 to selectively cover opening 32. Base 24 includes a base flange or coaming ring 34 that generally corresponds to opening 32 in bulk material container 22 and provides an upraised seating or sealing surface that is engaged by cover 26 in a closed position. Optionally, a gasket may be disposed between an underside of cover 26 and an upper and/or outer rim of base flange 34. An example of one such gasket may be found in commonly-owned U.S. Pat. No. 11,268,301, which is hereby incorporated herein by reference in its entirety. A pneumatic drive 36 such as an air compressor or compressed air tank (FIG. 1), is fluidly connected to a pneumatically-driven cover actuator 38 and a locking device 40 by a fluid conduit 42. Cover actuator 38 is mounted to bulk material container 22 and coupled to frame 28 via rotational shaft 30.

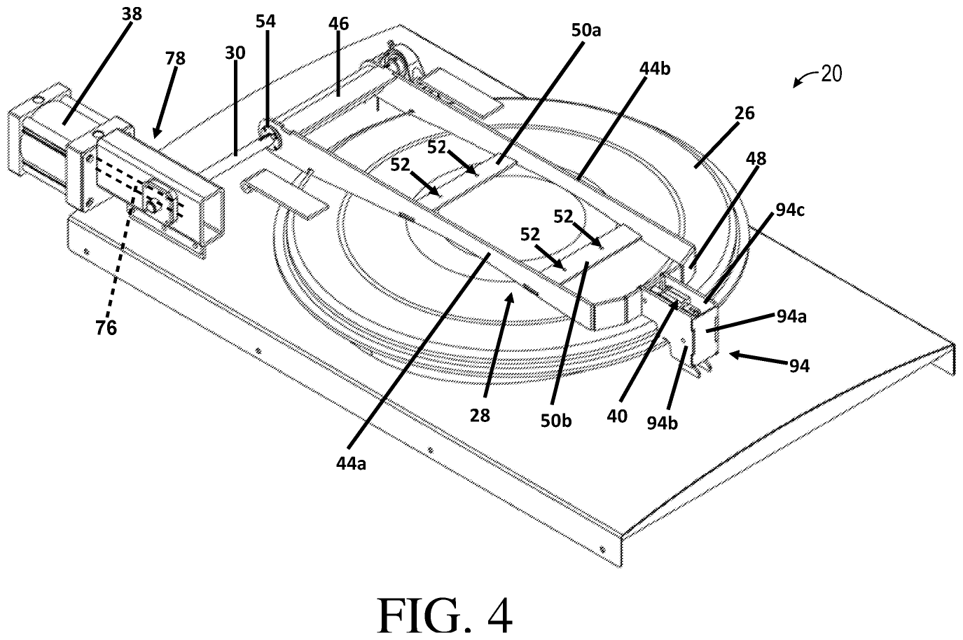

Frame 28 includes a pair of spaced apart support arms 44a, 44b connected by a proximal end member 46, a distal end member 48, and a pair of intermediate cross-members 50a, 50b (FIG. 4). Proximal end member 46 is coupled to rotational shaft 30 via a keyed bushing 54 so that the rotation of proximal member 46 and rotational shaft 30 are fixed together. Intermediate cross-members 50a, 50b are secured to cover 26 via bolts 52 and are welded to support arms 44a, 44b to attach frame 28 to cover 26. Distal end member 48 provides a mounting surface for coupling locking device 40 to cover 26. It should be appreciated that frame 28 may be coupled or attached to rotational shaft 30 in any suitable way that fixes the rotation of these components together, such as by a weld or one or more fasteners.

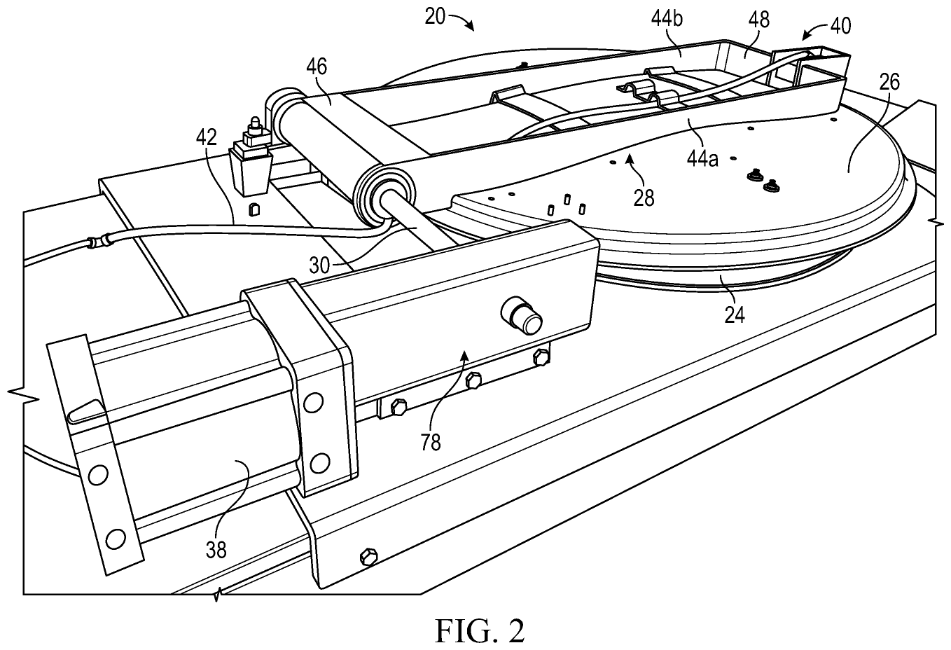

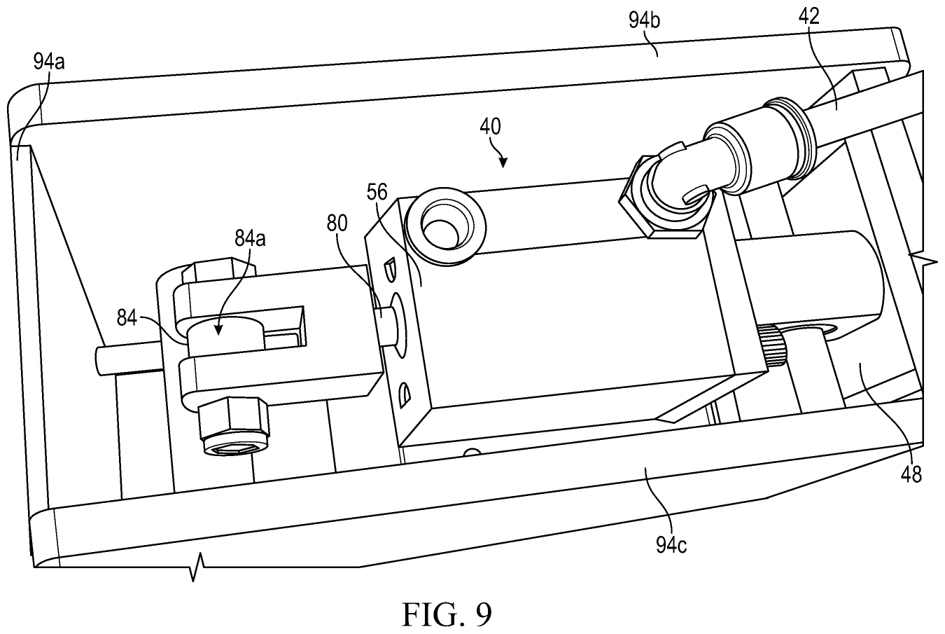

To actuate cover 26, pneumatic drive 36 generates a pneumatic force that is transferred through fluid conduit 42 to cover actuator 38 and a pneumatically-driven lock actuator 56 that is a component of locking device 40 (FIGS. 2, 6, 8, and 9). Because it is common for trains and trailer trucks to be equipped or supplied with pneumatic systems that operate certain functions, such as braking, such vehicles often include a convenient source for compressed air to provide the motive force for additional equipment such as hatch 20. Therefore, hatch 20 may utilize the pneumatic drive equipped on these vehicles to provide pneumatic force for actuation of pneumatically-operated components, though it will be appreciated that hatch 20 may instead be equipped with its own pneumatic drive source such as an electrically-powered or wheel-driven air compressor.

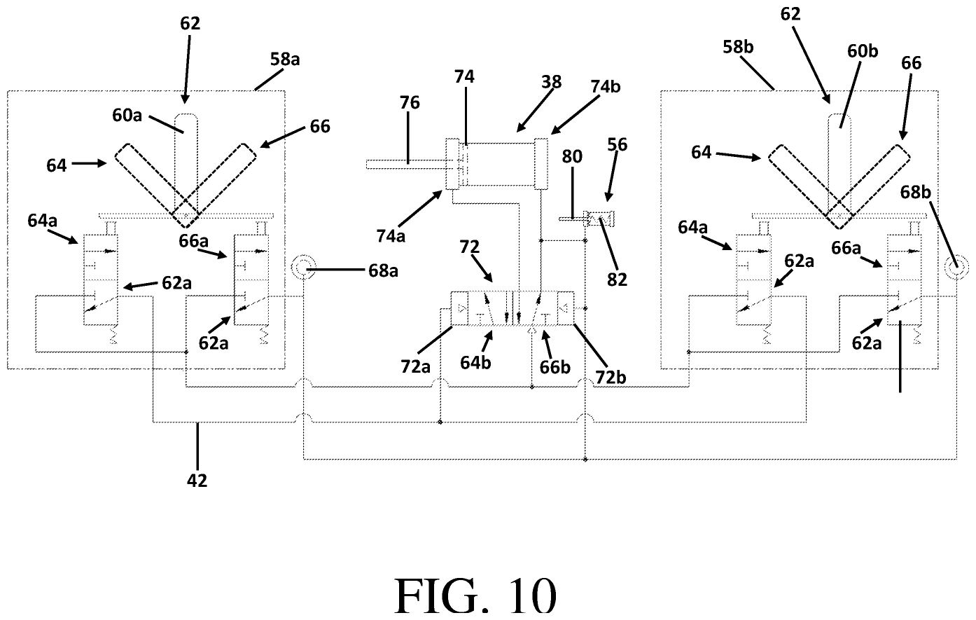

As shown in FIGS. 2, 3, and 9, fluid conduit 42 is a flexible hose that fluidly connects the pneumatically-actuated components of the system together. The pressurized air is directed through fluid conduit 42 in a direction controlled by operating either one of a pair of three-position valves 58a, 58b (FIG. 10). Each three-position valve 58a, 58b includes a respective remote hatch control in the form of a toggle switch 60a, 60b that remains in a default position 62 when not being manually actuated by an operator. Toggle switches 60a, 60b enable hatch 20 to be remotely operated by a user to open, close, lock, and unlock cover 26 from different locations. While both toggle switches 60a, 60b are in default position 62 (as shown in FIG. 10), fluid flow through fluid conduit 42 is prevented via blocked fluid paths 62a. An operator can move either toggle switch 60a, 60b to a closing position 64 or an opening position 66 (each position 64, 66 is represented with dashed lines in FIG. 10). Toggle switches 60a, 60b can be mounted in convenient locations for access by an operator of hatch 20. For example, as shown in FIG. 1, toggle switch 60a is a cab-mounted toggle switch accessible to an operator from the interior of a vehicle, while toggle switches 60b are mounted to a side of bulk material container 22.

For added operator convenience, a pair of pressure indicators 68a, 68b and a pair of hatch position indicators 70a, 70b may be mounted near each of toggle switches 60a, 60b (FIG. 1). Pressure indicators 68a, 68b provide the operator with an indication of the current pressure within fluid conduit 42. Hatch position indicators 70a, 70b display a red signal when cover 26 is open and a green signal when cover 26 is closed. It should be appreciated that a hatch position indicator could also indicate additional information such as whether cover 26 is locked or unlocked, or whether the cover is in-transit, or provide warnings such as low fluid pressure.

Referring again to FIG. 10, moving either toggle switch 60a, 60b to its respective closed position 64 will direct the elevated air pressure in fluid conduit 42 to enter a hatch-closing fluid path 64a in the corresponding three-position valve 58a, 58b. Hatch-closing fluid path 64a directs the pneumatic force to a first side 72a of a bidirectional valve 72. Pneumatic pressure acting on first side 72a of bidirectional valve 72 adjusts bidirectional valve 72 into a closing state where the elevated air pressure is conveyed to a second hatch-closing fluid path 64b. In the illustrated embodiment, cover actuator 38 is a piston-cylinder arrangement including a pneumatic cylinder 74 having a piston-mounted cover actuation rod 76 that is extendable and retractable in response to pressure changes within cylinder 74. Hatch-closing fluid path 64b creates a pressure differential between a first end 74a and a second end 74b of cylinder 74 by directing the pneumatic force to first end 74a while simultaneously releasing pneumatic pressure from second end 74b. The pneumatic pressure differential created on either side of the piston inside cylinder 74 causes cover actuation rod 76 to move (retract) from the higher pressure region at first end 74a to the lower pressure region at second end 74b.

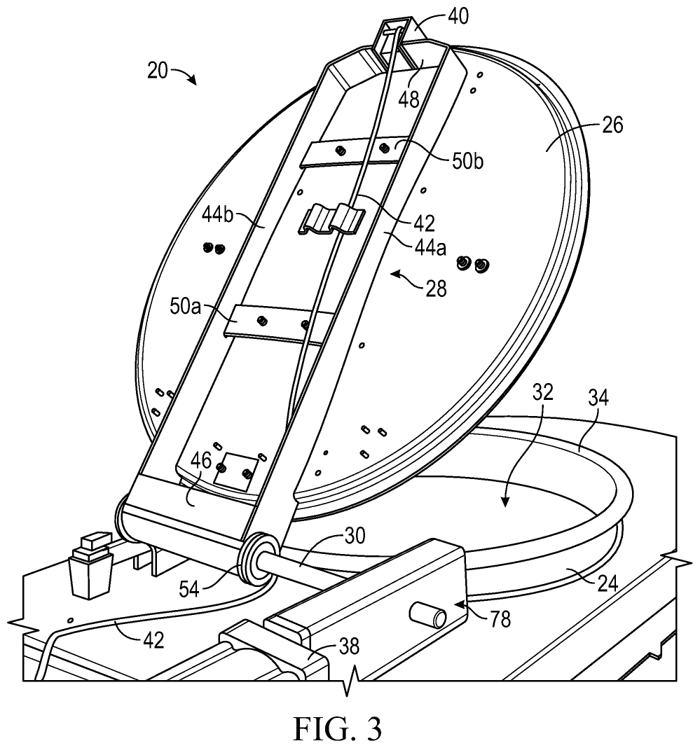

Cover actuation rod 76 is mechanically connected to a rack and pinion assembly 78 (FIGS. 2-5). Cover actuation rod 76 may be formed with a plurality of linearly-arranged gear teeth forming a “rack” that linearly extends and retracts along a rotatable pinion that is coupled to rotational shaft 30 inside rack and pinion assembly 78. Rotational motion of the pinion drives rotation of rotational shaft 30 around its longitudinal axis. Cover 26 rotates with rotational shaft 30 towards base 24 until cover 26 reaches the closed configuration in which base flange 34 has been covered by cover 26 (FIGS. 2 and 3).

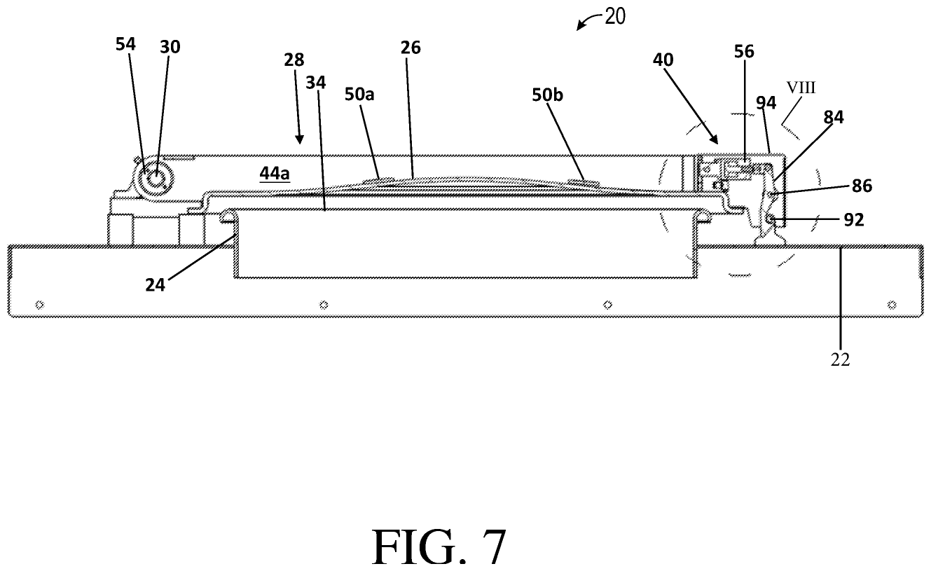

Lock actuator 56 is coupled to cover 26 as shown in FIG. 7, and includes a linear actuating pneumatic lock piston 80 and a resilient member, such as a spring 82, as shown in FIG. 10. Spring 82 exerts a biasing force on lock piston 80 in a locking direction, which is opposite to the pneumatic unlocking force selectively exerted on lock piston 80. While bidirectional valve 72 is in its hatch-closing state, described above, lock actuator 56 is fluidly connected to hatch-closing fluid path 64b. Hatch-closing fluid path 64b reduces pneumatic pressure from lock actuator 56 so that lock piston 80 can move to the locking position under the biasing force of the spring 82. As pneumatic pressure is reduced, the biasing force exerted by spring 82 overcomes the pneumatic force acting on lock piston 80 in lock actuator 56. As the biasing force of spring 82 overcomes the pneumatic force due to a reduction in pneumatic force, spring 82 retracts lock piston 80 into a cylinder of lock actuator 56.

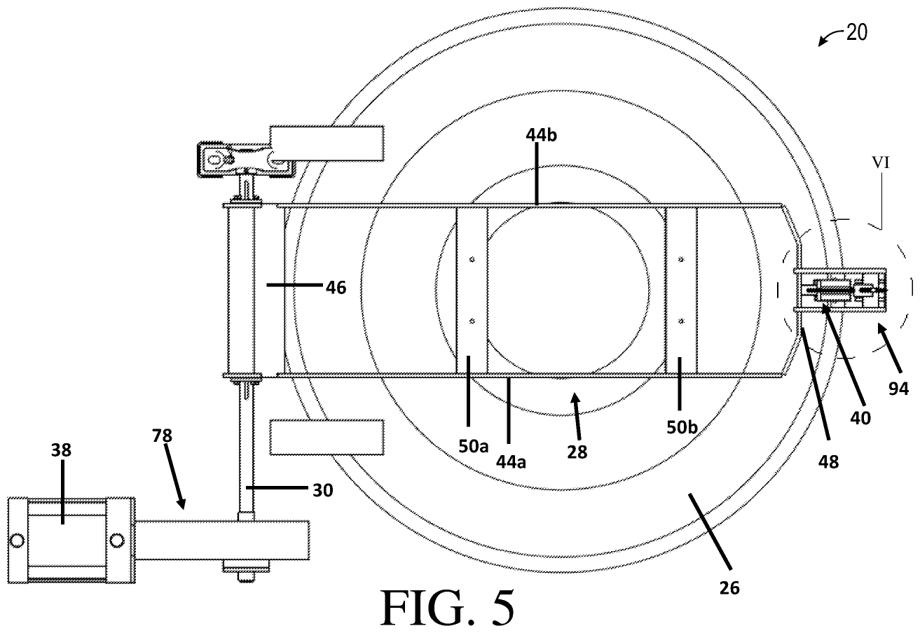

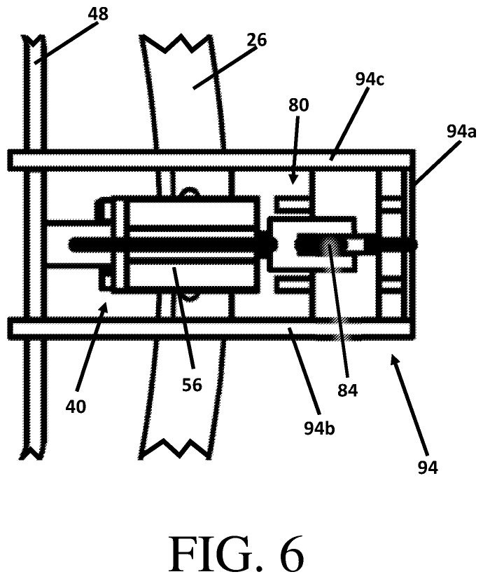

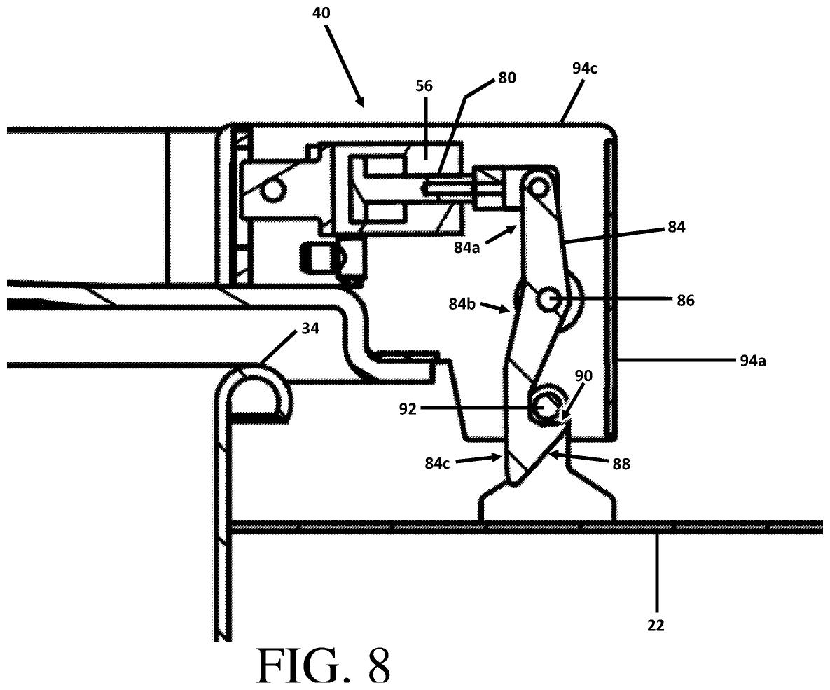

Referring to FIG. 8, a latch 84 having a proximal portion 84a, a center portion 84b, and a distal portion 84c, is connected at proximal portion 84a to lock piston 80. Latch 84 is pivotably connected to a latch pivot 86 at center portion 84b such that retraction of lock piston 80 causes latch 84 to rotate about latch pivot 86 into a locked position. A ramp surface 88 and a catch surface 90 are located at distal portion 84c of latch 84. As cover 26 rotates towards the closed configuration, ramp surface 88 engages a latch receiver 92 that projects from bulk material container 22, and slides along the surface of latch receiver 92. As ramp surface 88 slides along latch receiver 92, latch 84 pivots towards the unlocked position (not shown). After ramp surface 88 slides past latch receiver 92, latch 84 pivots back to the locked position where catch surface 90 engages with latch receiver 92 to lock cover 26 in the closed configuration. A lock guard 94 (FIGS. 5 and 6) is mounted to frame 28 and includes a distally located security plate 94a connected to a pair of spaced side security plates 94b, 94c to offer protection and deter tampering with locking device 40.

As shown in FIG. 10, moving either toggle switch 60a, 60b to its respective opening position 66 will direct the air pressure in fluid conduit 42 to a hatch-opening fluid path 66a in the corresponding three-position valve 58a, 58b. Hatch-opening fluid path 66a directs pneumatic force to a second side 72b of bidirectional valve 72. Pneumatic pressure acting on second side 72b of bidirectional valve 72 adjusts bidirectional valve 72 into an opening state so that the increased air pressure is received in a second hatch-opening fluid path 66b. Hatch-opening fluid path 66b places second end 74b of cover actuator cylinder 74 and lock actuator 56 in fluid parallel, and places these components collectively in fluid series with pneumatic drive 36. Hatch-opening fluid path 66b simultaneously provides a fluid path to reduce pneumatic pressure at first end 74a of cover actuator cylinder 74 to create a pressure differential between first end 74a and second end 74b. In this arrangement, pneumatic pressure is increased at second end 74b of cover actuator cylinder 74 as well as lock actuator 56, and is reduced at first end 74a of cover actuator cylinder 74.

As the pneumatic pressure acting on lock actuator 56 is increased, the biasing force exerted on lock piston 80 by spring 82 is overcome by the pneumatic force. As the spring biasing force is overcome, the pneumatic force moves lock piston 80 to extend from the cylinder of lock actuator 56. The extension of lock piston 80 pivots latch 84 about latch pivot 86 into an unlocked position in which catch surface 90 becomes disengaged from latch receiver 92.

The pneumatic pressure acting on both lock actuator 56 and second end 74b of pneumatic cylinder 74 continues to increase after lock piston 80 has been fully extended. After lock piston 80 has been fully extended and the pneumatic pressure acting on second end 74b has further increased, actuation rod 76 is moved (extended) towards the lower pressure region at first end 74a of cylinder 74. Rack and pinion assembly 78 converts the linear motion of cover actuation rod 76 into rotational motion of rotational shaft 30 about its longitudinal axis (FIGS. 2-5). Rotational shaft 30 rotates cover 26 upwardly and away from base 24 until the open configuration is reached.

As a result of the above-described process, the pneumatic actuation of cover actuator 38 as a result of higher air pressure begins only after lock actuator 56 has moved from its locked position to its unlocked position at an earlier, lower air pressure. Movement of lock actuator 56 and cover actuator 38 in this sequence ensures the free opening movement of cover 26 towards the open configuration without interference by latch 84. However, it is envisioned that a fluid-driven hatch could operate in such a way that fluid actuation of a cover actuator and a lock actuator occur at the same pressure while remaining within scope of the present invention, such as by shaping the latch's catch surface to ensure it can release even if there is lifting force being applied to the hatch, or by designing the lock actuator to operate more quickly than the cover actuator at the same air pressure.

It should be recognized that alternative embodiments of a fluid-driven hatch are possible while remaining within the spirit and scope of the present invention. For example, a hatch could have a frame with a single support arm and no intermediate cross-members. Optionally, a fluid-driven hatch may not have a frame at all, and could instead include a cover mounted at one end to a base via a hinge.

Another form of a hatch could include a fluid conduit that is a rigid pipe rather than a flexible hose. Furthermore, portions of a fluid conduit could include internal channels defined by other components, such as a cover.

It should also be recognized that the process and components used to move a cover between open and closed configurations may vary within the scope of the present invention. For example, a cover actuator could include a piston that extends and retracts to directly engage with and move a cover between open and closed configurations. In this alternative form, structures such as rotational shaft 30 or frame 28 would be unnecessary as the cover actuator would be in direct contact with the cover to provide motion. Optionally, a cover could be moved between open and closed configurations by sliding horizontally along a pair of rails mounted on each side of a base. In another form, a cover could be rotated in a horizontal plane between an open and closed configuration. Furthermore, a resilient member such as a spring could eliminate the need for a bidirectional valve used to extend and retract a cover actuation rod by altering the direction of a fluid force. A cover actuator in this form would operate in a similar manner as lock actuator 56, described above, in which the balance of the spring biasing force and the fluid force would determine extension and retraction of a rod or member. In another alternative form, a resilient member such as a spring could be connected directly or indirectly to a portion of a cover to bias the cover once a certain degree of rotation has been reached during the opening or closing operation. In this form, fluid force would move the cover for an initial portion of the opening or closing sequence, and biasing force exerted by the spring would move the cover the remainder of the opening or closing sequence. In yet another form, a fluid-driven hatch may move a cover through fluid actuation only to a point where the cover would then rotate downward solely under the force of gravity to reach an open or closed configuration.

Alternative forms of locking device 40 are also envisioned within the scope of the present invention. For example, a locking device may include a latch in the form of a locking pin that extends into a locking pin receiver, or catch, to lock a cover in a closed configuration. In this alternative form, the locking device would transition into an unlocked position by retracting the locking pin out of the catch. Optionally, a locking device could include a latch mounted to a cover in which the latch pivots to securely engage with an annular flange attached to a base flange. Other variations of a fluid-driven hatch may include a locking device or multiple locking devices mounted to a base or a bulk material container rather than a cover. Similarly, a latch receiver or multiple latch receivers could be mounted to (or be an integral extension of) a base, a cover, or a bulk material container. Furthermore, a locking device may operate in a manner similar to cover actuator 38, described above, in which a bidirectional valve governs the extension and retraction of a lock piston by altering the direction of a fluid force. In this form, there would be no need for a resilient member, such as spring 82, in the lock actuator.

Finally, it should be recognized that a fluid-driven hatch may be operated with fluids other than air. For example, a hydraulically-driven hatch assembly could use a liquid as an energy transfer medium to actuate a cover actuator and a lock actuator. Certain components of a pneumatically-driven hatch, such as valves, cylinders, and conduits, may be replaced with appropriate counterpart components based on the fluid being used to transfer energy within a fluid-driven hatch. For example, a pneumatic drive source may be replaced by a hydraulic pump or other source of pressurized liquid in a hydraulically-driven hatch assembly.

Accordingly, the fluid-driven hatch of the present invention provides an effective way to utilize a fluid drive source to selectively cover an opening in a bulk material container. The fluid drive source supplies elevated fluid pressure to a fluid conduit that is in communication with both a fluid-driven cover actuator and a fluid-driven lock actuator. The fluid-driven cover actuator moves a cover or lid to selectively cover an opening in the bulk material container. The fluid-driven lock actuator secures the cover to the container when the cover is covering the container opening, and is unlocked at a lower initial fluid pressure before the fluid pressure builds to a higher level at which the cover actuator is able to raise the cover.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A fluid-driven hatch for a bulk material container, said hatch comprising:
a fluid-driven cover actuator configured to be coupled at a hatch opening in the bulk material container;
a cover coupled to said fluid-driven cover actuator and movable in response to said fluid-driven cover actuator, between an open configuration wherein the hatch opening is substantially uncovered, and a closed configuration wherein the hatch opening is substantially covered;
a locking device comprising a latch and a fluid-driven lock actuator adapted to selectively move said latch from a locked position to an unlocked position when said cover is in said closed configuration; and
a fluid conduit that fluidly connects said fluid-driven cover actuator, said fluid-driven lock actuator, and a fluid drive source;
wherein said fluid-driven lock actuator is configured to move said latch from said locked position to said unlocked position when said fluid conduit reaches a first internal pressure; and
wherein said fluid-driven cover actuator is configured to urge said cover from said closed configuration to said open configuration when said fluid conduit reaches a second internal pressure.

2. The fluid-driven hatch of claim 1, wherein when said cover is in said closed configuration, said latch is configured to move from said locked position to said unlocked position in response to said first internal pressure before said cover begins to move from said closed configuration to said open configuration in response to said second internal pressure.

3. The fluid-driven hatch of claim 1, wherein said locking device further comprises a latch pivot, said latch pivotably coupled to said latch pivot and adapted to selectively move about said latch pivot in response to said fluid-driven lock actuator, wherein said latch is engaged with a latch receiver in said locked position to secure said cover in said closed configuration, and wherein said latch is disengaged from the latch receiver in said unlocked position.

4. The fluid-driven hatch of claim 1, wherein said fluid-driven cover actuator and said fluid-driven lock actuator are fluidly connected in parallel by said fluid conduit.

5. The fluid-driven hatch of claim 1, wherein said first internal pressure is lower than said second internal pressure.

6. The fluid-driven hatch of claim 5, further comprising a remote hatch control operable to selectively move said cover between said open configuration and said closed configuration.

7. The fluid-driven hatch of claim 1, further comprising a bidirectional valve that is fluidly connected to said fluid conduit and configured to be selectively toggled between an opening state that increases the fluid pressure at said fluid-driven lock actuator to said first internal pressure, and a closing state that reduces the fluid pressure at said fluid-driven lock actuator to less than said first internal fluid pressure.

8. The fluid-driven hatch of claim 7, wherein said fluid-driven cover actuator comprises a first end, a second end, and a cover actuation rod, wherein when said bidirectional valve is in said opening state the fluid pressure of said second end increases to said second internal pressure to urge said cover actuation rod away from said second end of said fluid-driven cover actuator.

9. The fluid-driven hatch of claim 8, further comprising a rack and pinion assembly coupled to said cover and to said cover actuation rod, wherein as said cover actuation rod is urged away from said second end of said fluid-driven cover actuator, said rack and pinion assembly is actuated to rotate said cover towards said open configuration.

10. The fluid-driven hatch of claim 9, wherein said locking device further comprises a latch pivot, said latch pivotably coupled to said latch pivot and adapted to selectively move about said latch pivot in response to said fluid-driven lock actuator, wherein said latch is engaged with a latch receiver in said locked position to secure said cover in said closed configuration, and wherein said latch is disengaged from the latch receiver in said unlocked position.

11. The fluid-driven hatch of claim 10, wherein said latch comprises a distal portion having a ramp surface and a catch surface, said ramp surface configured to slide along the latch receiver as said cover moves to said closed configuration, wherein said latch pivots away from said locked position as said ramp surface slides along the latch receiver and said latch pivots back towards said locked position once said ramp surface has slid past the latch receiver, wherein said catch surface engages with the latch receiver to secure said cover in said closed configuration.

12. The fluid-driven hatch of claim 11, further comprising a resilient member coupled to said fluid-driven lock actuator and configured to exert a biasing force on said fluid-driven lock actuator in a direction opposite to a fluid force exerted upon said fluid-driven lock actuator by the fluid drive.

13. The fluid-driven hatch of claim 12, wherein said locking device is coupled to said cover.

14. A fluid-driven hatch for a bulk material container, said hatch comprising:
a fluid-driven cover actuator configured to be coupled at a hatch opening in the bulk material container;
a cover coupled to said fluid-driven cover actuator and movable in response to said fluid-driven cover actuator, between an open configuration wherein the hatch opening is substantially uncovered, and a closed configuration wherein the hatch opening is substantially covered;
a locking device coupled to said cover and comprising a latch and a fluid-driven lock actuator adapted to selectively move said latch from a locked position to an unlocked position when said cover is in said closed configuration;
a fluid conduit that fluidly connects said fluid-driven cover actuator, said fluid-driven lock actuator, and a fluid drive source; and
a remote hatch control operable to selectively move said cover between said open configuration and said closed configuration, and to selectively move said latch between said locked position and said unlocked position;
wherein said fluid-driven lock actuator is configured to move said latch from said locked position to said unlocked position when said fluid conduit reaches a first internal pressure; and
wherein said fluid-driven cover actuator is configured to urge said cover from said closed configuration to said open configuration when said fluid conduit reaches a second internal pressure.

15. The fluid-driven hatch of claim 14, wherein said first internal pressure is lower than said second internal pressure.

16. The fluid-driven hatch of claim 14, further comprising a bidirectional valve that is fluidly connected to said fluid conduit and configured to be selectively toggled between an opening state that increases the fluid pressure at said fluid-driven lock actuator to said first internal pressure, and a closing state that reduces the fluid pressure at said fluid-driven lock actuator to less than said first internal fluid pressure.

17. The fluid-driven hatch of claim 14, wherein said locking device further comprises a latch pivot, said latch coupled to said latch pivot and adapted to selectively move about said latch pivot in response to said fluid-driven lock actuator, wherein said latch is engaged with a latch receiver in said locked position to secure said cover in said closed configuration, and wherein said latch is disengaged from the latch receiver in said unlocked position.

18. A method of opening a hatch for a bulk material container, said method comprising:
actuating a fluid-driven lock actuator by increasing fluid pressure in a fluid conduit to a first internal pressure;
moving a latch to an unlocked position in response to said actuating the fluid-driven lock actuator to unsecure a cover in a closed configuration;
actuating a fluid-driven cover actuator by increasing the fluid pressure in the fluid conduit to a second internal pressure that is higher than the first internal pressure; and
moving the cover from the closed configuration to an open configuration in which the hatch opening is substantially uncovered, in response to said actuating the fluid-driven cover actuator.

19. The method of claim 18, further comprising operating a remote hatch control to increase the fluid pressure in the fluid conduit to the first internal pressure and to the second internal pressure.

20. The method of claim 19, further comprising operating the remote hatch control to decrease the fluid pressure in the fluid conduit to move the cover from the open configuration to the closed configuration, and to move the latch to a locked position to secure the cover in the closed configuration.
